(19) United States
(12) Patent Application Publication
(10) Pub. No.: US 2008/0245390 A1
(43) Pub. Date: Oct. 9, 2008

(54) Method for cleaning semiconductor wafer surfaces by applying periodic shear stress to the cleaning solution

(75) Inventors: Erik M. Freer, Campbell, CA (US); John M. de Larios, Palo Alto, CA (US); Michael Ravkin, Sunnyvale, CA (US); Mikhail Korolik, San Jose, CA (US); Fritz C. Redeker, Fremont, CA (US)

Correspondence Address: MARTINE PENILLA & GENCARELLA, LLP, 710 LAKEWAY DRIVE, SUITE 200, SUNNYVALE, CA, 94085, US

(73) Assignee: LAM RESEARCH CORPORATION, Fremont, CA (US)

(21) Appl. No.: 11/732,603

(22) Filed: Apr. 3, 2007

(51) Int. Cl. B08B 3/12

(52) U.S. Cl. 134/1.3; 134/184; 134/198; 134/99.1

(57) ABSTRACT

Systems and methods for cleaning particulate contaminants adhered to wafer surfaces are provided. A cleaning media including dispersed coupling elements suspended within the cleaning media is applied over a wafer surface. External energy is applied to the cleaning media to generate periodic shear stresses within the media. The periodic shear stresses impart momentum and/or drag forces on the coupling elements causing the coupling elements to interact with the particulate contaminants to remove the particulate contaminants from the wafer surfaces.

### CROSS REFERENCE TO RELATED APPLICATIONS

This application is related to U.S. patent application Ser. No. 10/816,337, filed Mar. 31, 2004, and entitled “Apparatuses and Methods for Cleaning a Substrate”; U.S. patent application Ser. No. 11/153,957, filed Jun. 15, 2005, and entitled “Method and Apparatus for Cleaning a Substrate Using Non-Newtonian Fluids”; U.S. patent application Ser. No. 11/154,129, filed Jun. 15, 2005, and entitled “Method and Apparatus for Transporting a Substrate Using Non-Newtonian Fluid”; U.S. patent application Ser. No. 11/174,080, filed Jun. 30, 2005, and entitled “Method for Removing Material from Semiconductor Wafer and Apparatus for Performing the Same”; U.S. patent application Ser. No. 10/746,114, filed Dec. 23, 2003, and entitled “Method and Apparatus for Cleaning Semiconductor Wafers using Compressed and/or Pressurized Foams, Bubbles, and/or Liquids”; U.S. patent application Ser. No. 11/336,215 (Atty. Docket No. LAM2P545), filed Jan. 20, 2006, entitled “Method and Apparatus for Removing Contamination from a Substrate”; U.S. patent application Ser. No. 11/346,894 (Atty. Docket No. LAM2P546), filed Feb. 3, 2006, entitled “Method for Removing Contamination from a Substrate and for Making a Cleaning Solution”; U.S. patent application Ser. No. 11/347,154 (Atty. Docket No. LAM2P547), filed Feb. 3, 2006, and entitled “Cleaning Compound and Method and System for Using the Cleaning Compound”; U.S. patent application Ser. No. 11/532,491 (Atty. Docket No. LAM2P548B), filed Sep. 15, 2006, and entitled “Method and Material for Cleaning a Substrate”; U.S. patent application Ser. No. 11/532,493 (Atty. Docket No. LAM2P548C), filed Sep. 15, 2006, and entitled “Apparatus and System for Cleaning Substrate”; U.S. patent application Ser. No. 11/543,365 (Atty. Docket No. LAM2P562), filed Oct. 4, 2006, and entitled “Method and Apparatus for Particle Removal”; and U.S. patent application Ser. No. 11/641,362 (Atty. Docket No. LAM2P581), filed Dec. 18, 2006, and entitled “Substrate Preparation Using Stabilized Fluid Solutions and Methods for Making Stable Fluid Solutions.” The disclosures of each of the above-identified related applications are incorporated herein by reference.

### BACKGROUND

In the fabrication of semiconductor devices such as integrated circuits, memory cells, and the like, a series of manufacturing operations are performed to define features on semiconductor wafers (“wafers”). The wafers include integrated circuit devices in the form of multi-level structures defined on a silicon substrate. At a substrate level, transistor devices with diffusion regions are formed. In subsequent levels, interconnect metallization lines are patterned and electrically connected to the transistor devices to define a desired integrated circuit device. Also, patterned conductive layers are insulated from other conductive layers by dielectric materials.

During the series of manufacturing operations, the wafer surface is exposed to various types of contaminants. Essentially any material present in a manufacturing operation is a potential source of contamination. For example, sources of contamination may include process gases, chemicals, deposition materials, and liquids, among others. The various contaminants may deposit on the wafer surface in particulate form. If the particulate contamination is not removed, the devices within the vicinity of the contamination will likely be inoperable. Thus, it is necessary to clean contamination from the wafer surface in a substantially complete manner without damaging the features defined on the wafer. However, the size of particulate contamination is often on the order of the critical dimension size of features fabricated on the wafer. Removal of such small particulate contamination without adversely affecting the features on the wafer can be difficult.

Conventional wafer cleaning methods have relied heavily on mechanical force to remove particulate contamination from the wafer surface. As feature sizes continue to decrease and become more fragile, the probability of feature damage due to application of mechanical force to the wafer surface increases. For example, features having high aspect ratios are vulnerable to toppling or breaking when impacted by a sufficient mechanical force. To further complicate the cleaning problem, the move toward reduced feature sizes also causes a reduction in the size of particulate contamination. Particulate contamination of sufficiently small size can find its way into difficult to reach areas on the wafer surface, such as in a trench surrounded by high aspect ratio features. Thus, efficient and non-damaging removal of contaminants during modern semiconductor fabrication represents a continuing challenge to be met by continuing advances in wafer cleaning technology. It should be appreciated that the manufacturing operations for flat panel displays likewise suffer from the same shortcomings of the integrated circuit manufacturing discussed above.

In view of the forgoing, there is a need for a more efficient, more effective and less abrasive methods for cleaning wafer surfaces.

### SUMMARY

In one embodiment, the present invention provides a wafer cleaning method. The method comprises providing a wafer having a surface and the surface having a particle thereon. The method also comprises providing a cleaning media on the surface, where the cleaning media includes one or more dispersed coupling elements suspended therein. The method further comprises applying external energy to the cleaning media, where the application of the external energy to the cleaning media generates a periodic shear stress within the cleaning media. The periodic shear stress imparts a force on at least one of the one or more of the coupling elements, where the force causes an interaction between the at least one of the one or more coupling elements and the particle to remove the particle from the surface.

In another embodiment, the present invention provides a wafer cleaning system. The system comprises a carrier for supporting a wafer having a surface, the surface having a particle thereon. The system also comprises a tank having a cavity defined by a base and one or more sidewalls extending there from. The tank is configured to hold a volume of the cleaning media within the cavity to immerse the wafer, where the cleaning media includes one or more dispersed coupling elements suspended therein. The system further comprises one or more transducers coupled to at least one of the one or more sidewalls, the one or more transducers applying acoustic energy to the cleaning media. The acoustic energy generates a periodic shear stress within the cleaning media. The periodic shear stress imparts a force on at least one of the one or more dispersed coupling elements causing the at least one of the one or more dispersed coupling elements to interact with the particle to remove the particle from the surface of the wafer.

In another embodiment, provides a wafer cleaning system. The system comprises a processing chamber having a carrier element, the carrier element being capable of supporting a wafer within the processing chamber such that a surface of the wafer is exposed. The exposed wafer surface having a particle thereon. The system further comprises a jet assembly. The jet assembly is configured to generate acoustic energy and apply the acoustic energy to a cleaning media as the cleaning media travels along a throughway of the jet assembly, where the cleaning media includes one or more dispersed coupling elements suspended therein and the acoustic energy generated by the jet assembly alters a physical characteristic of each of the dispersed coupling elements before application of the cleaning media to the exposed wafer surface. The jet assembly is also configured such that fluid motion from a jet of the jet assembly imparts a force on at least one of the altered one or more dispersed coupling elements of the cleaning media causing the at least one of the altered one or more dispersed coupling element to interact with the particle to remove the particle from the surface of the wafer.

In another embodiment, the present invention provides a wafer cleaning system. The system comprises a processing chamber having a carrier element, the carrier element being capable of supporting a wafer within the processing chamber such that a surface of the wafer having a particle disposed thereon is exposed. The system also comprises a fluid supply assembly that is configured to supply a cleaning media to the exposed wafer surface, where the cleaning media includes one or more dispersed coupling elements suspended therein. The system further comprises an energy source capable of generating acoustic energy, where the acoustic energy is applied to the cleaning media at the exposed wafer surface, thereby generating a periodic shear stress within the cleaning media such that the periodic shear stress imparts a force on at least one of the one or more dispersed coupling elements. The force causing the at least one of the one or more dispersed coupling elements to interact with the particle to remove the particle from the surface.

In yet another embodiment, the present invention provides a wafer cleaning system. The system comprises a transducer disposed proximally to a back surface of a wafer where the transducer is capable of generating acoustic energy and the wafer includes a front surface opposite the back surface, the front surface having a particle disposed thereon. The system also comprises a first fluid supply assembly that is capable of supplying a liquid layer between the back surface of the wafer and the transducer. The system further comprises a second fluid supply assembly, where the second fluid supply assembly is capable of supplying a cleaning media including one or more dispersed coupling elements suspended therein on the front surface of the wafer. The acoustic energy is transferred from the transducer through the liquid layer and the wafer into the cleaning media at the front surface of the wafer, thereby generating a periodic shear stress within the cleaning media. The periodic shear stress imparts a force on at least one of the one or more dispersed coupling elements causing the at least one of the one or more dispersed coupling elements to interact with the particle to remove the particle from the front surface.

Other aspects and advantages of the invention will become apparent from the following detailed description, taken in conjunction with the embodiments and accompanying drawings, illustrating, by way of example, the principles of the invention.

### BRIEF DESCRIPTION OF THE DRAWINGS

The invention, together with further advantages thereof, may best be understood by reference to the following description taken in conjunction with the accompanying drawings in which:

FIG. 1 is an illustration of interactions between dispersed coupling elements suspended in a cleaning media and particulate contaminants resulting from the application of external energy to the cleaning media;

FIG. 2 is an illustration of a periodic shear stress imparting drag forces on a coupling element to remove a particulate contaminant adhered to a wafer surface by an adhesion force;

FIG. 3 is an illustration of comparative critical periodic stress requirements for removing particulate contamination;

FIG. 4 is an illustration of a system for removing contaminants from a wafer surface by creating periodic shear stresses in cleaning media including dispersed coupling elements;

FIG. 5 is an illustration of an alternate system for removing contaminants from a wafer surface by creating periodic shear stresses in cleaning media including dispersed coupling elements;

FIG. 6 is an illustration of an alternate system for removing contaminants from a wafer surface by creating periodic shear stresses in cleaning media including dispersed coupling elements;

FIG. 7 is an illustration of an alternate system for removing contaminants from a wafer surface by creating periodic shear stresses in cleaning media including dispersed coupling elements; and

FIG. 8 is an illustration of a method for removing contaminants from a wafer surface by creating periodic shear stresses in cleaning media including dispersed coupling elements.

### DETAILED DESCRIPTION

Embodiments of the present invention provide systems and methods for cleaning wafer surfaces. More particularly, embodiments of present invention provide an efficient approach for applying external mechanical energy to particulate contamination on wafer surfaces by combining multi-state body cleaning technologies with an alternative means for applying momentum and/or drag to coupling elements suspended within the cleaning media associated with multi-state body cleaning technologies. By providing the cleaning media on exposed wafer surfaces and applying external energy to the cleaning media, periodic shear stresses or pressure gradients can be created within the cleaning media. These periodic shear stresses or pressure gradients then act to impart drag and/or momentum forces on the coupling elements thereby causing interactions between the coupling elements and the particulate contaminants. The interactions between the coupling elements and the particulate contaminants facilitate the removal of the particulate contaminants from the wafer surfaces. This approach increases contaminant removal efficiency by providing additional agitation and/or motion control to the coupling elements suspended within the multi-state body cleaning media. Moreover, by controlling how and with what magnitude the external energy is applied to the cleaning media, momentum and drag forces generated by the application of external energy can be more closely controlled which in turn can eliminate undesired device damage.

The cleaning media as used herein can be associated with “multi-state body technology” or any other cleaning fluid, solution or material that is engineered to include dispersed suspended “coupling elements” or “solids.” Multi-state body technology can be any three-phase or “tri-state body” fluid or any two-phase or “bi-state body” fluid. As used herein tri-state body cleaning fluids include a gas phase, a liquid phase, and a solid phase component. Whereas bi-state body cleaning fluids include only the liquid phase and the solid phase component. The solid phase components of tri-state and bi-state body cleaning fluids are referenced herein as “coupling elements” or “solids.” The gas phase component (of tri-state body fluids/materials) and the liquid phase components (of tri-state and bi-state body fluids/materials) can provide an intermediary to bring the solid phase component into close proximity with contaminant particles on a wafer surface. The solid phase component avoids dissolution into the liquid phase and gas phase components and has a surface functionality that enables dispersion throughout the liquid phase component. Although a brief discussion of the components of bi-state and tri-state body cleaning technology is provided below, further explanation of the components and mechanisms of tri-state body cleaning technology can be found by reference to: U.S. patent application Ser. No. (11/346,894) (Atty. Docket No. LAM2P546), filed Feb. 3, 2006, entitled “Method for removing contamination from a substrate and for making a cleaning solution”; U.S. patent application Ser. No. 11/347,154 (Atty. Docket No. LAM2P547), filed Feb. 3, 2006, entitled “Cleaning compound and method and system for using the cleaning compound”; and U.S. patent application Ser. No. (11/336,215) (Atty. Docket No. LAM2P545), filed Jan. 20, 2006, entitled “Method and Apparatus for removing contamination from a substrate.” In particular, further explanation of the components and mechanisms of bi-state body or two-phase cleaning technology can be found by reference to U.S. patent application Ser. No. 11/543,365 (Atty. Docket No. LAM2P562), filed Oct. 4, 2006, and entitled “Method and Apparatus for Particle Removal.”

The gas phase component of tri-state body fluids or materials can be defined to occupy about 5% to about 99.9% of the tri-state body cleaning fluid by volume. The gas or gases defining the gas phase component can be either inert, e.g., nitrogen (N₂), argon (Ar), etc.; or reactive, e.g., oxygen (O₂), ozone (O₃), hydrogen peroxide (H₂O₂), air, hydrogen (H₂), ammonia (NH₃), hydrogen fluoride (HF), hydrochloric acid (HCl), etc. In one embodiment, the gas phase component includes only a single type of gas, for example, nitrogen (N₂). In another embodiment, the gas phase component is a gas mixture that includes mixtures of various types of gases, such as: ozone (O₃), oxygen (O₂), carbon dioxide (CO₂), hydrochloric acid (HCl), hydrofluoric acid (HF), nitrogen (N2), and argon (Ar); ozone (O₃) and nitrogen (N₂); ozone (O₃) and argon (Ar); ozone (O₃), oxygen (O₂) and nitrogen (N₂); ozone (O₃), oxygen (O₂) and argon (Ar); ozone (O₃), oxygen (O₂), nitrogen (N2), and argon (Ar); and oxygen (O₂), argon (Ar), and nitrogen (N₂). However, it should be appreciated that the gas phase component can include essentially any combination of gas types as long as the resulting gas mixture can be combined with a liquid phase component and a solid phase component to form a tri-state body cleaning fluids or materials that can be utilized in substrate cleaning or preparation operations.

The solid phase component of bi-state and tri-state body fluids or materials can take one or more of several different forms. For example, the solid phase component can form aggregates, colloids, gels, coalesced spheres, or essentially any other type of agglutination, coagulation, flocculation, agglomeration, or coalescence. It should be appreciated that the exemplary list of solid phase component forms identified above is not intended to represent an inclusive list, and alternates or extensions falling within the spirit of the disclosed embodiments are possible. It should further be understood that the solid phase component can be defined as essentially any solid material capable of functioning in the manner described herein with respect to their interactions with wafer surfaces and contaminant particles. For example, some exemplary types of materials that can be used to make up the solid phase component include aliphatic acids, carboxylic acids, paraffin, wax, polymers, polystyrene, polypeptides, and other visco-elastic materials. The solid phase component material should be present at a concentration that exceeds its solubility limit within the liquid phase component. Aliphatic acids represent essentially any acid defined by organic compounds in which carbon atoms form open chains. A fatty acid is an example of an aliphatic acid that can be used as the solid phase component within the bi-state body and tri-state body cleaning fluids. Examples of fatty acids that may be used as the solid phase component include lauric acid, palmitic acid, stearic acid, oleic acid, linoleic acid, linolenic acid, arachidonic acid, gadoleic acid, eurcic acid, butyric acid, caproic acid, caprylic acid, myristic acid, margaric acid, behenic acid, lignoseric acid, myristoleic acid, palmitoleic acid, nervanic acid, parinaric acid, timnodonic acid, brassic acid, clupanodonic acid, lignoceric acid, cerotic acid, and mixtures thereof, among others. In one embodiment, the solid phase component can represent a mixture of fatty acids defined by various carbon chain lengths extending from C-1 to about C-26. Carboxylic acids are defined by essentially any organic acid that includes one or more carboxyl groups (COOH). When used as the solid phase component of a bi-state body and tri-state body cleaning fluid the carboxylic acids can include mixtures of various carbon chain lengths extending from about C-8 through about C-100. Also, the carboxylic acids can include other chemical functionalities (i.e. alcohols, ethers, and/or ketones)

The liquid phase component of bi-state body and tri-state body fluids or materials can be either aqueous or non-aqueous. For example, an aqueous liquid phase component can be defined by water (de-ionized or otherwise) alone. An aqueous liquid phase component is defined by water in combination with other constituents that are in solution with the water. In still another embodiment, a non-aqueous liquid phase component is defined by a hydrocarbon, a fluorocarbon, a mineral oil, or an alcohol, among others. Irrespective of whether the liquid phase component is aqueous or non-aqueous, it should be understood that the liquid phase component can be modified to include ionic or non-ionic solvents and other chemical additives. For example, the chemical additives to the liquid phase component can include any combination of co-solvents, pH modifiers (e.g., acids and bases), chelating agents, polar solvents, surfactants, ammonia hydroxide, hydrogen peroxide, hydrofluoric acid, potassium hydroxide, sodium hydroxide, tetramethylammonium hydroxide, and rheology modifiers such as polymers, particulates, and polypeptides.

A “wafer” as used herein, denotes without limitation, substrates, semiconductor wafers, hard drive disks, optical discs, glass substrates, flat panel display surfaces, or liquid crystal display surfaces, etc. Depending on the actual wafer, a surface may become contaminated in different ways, and the acceptable level of contamination or type of contamination is defined in the context of the particular industry in which the wafer is handled.

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention. The present invention includes several aspects and is presented below and discussed in connection with the Figures and embodiments.

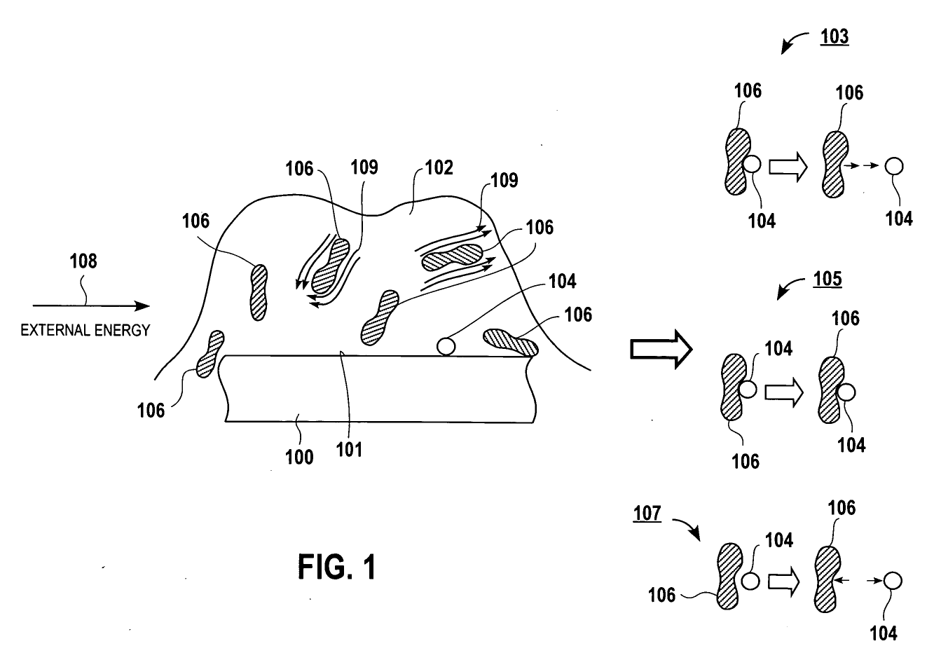

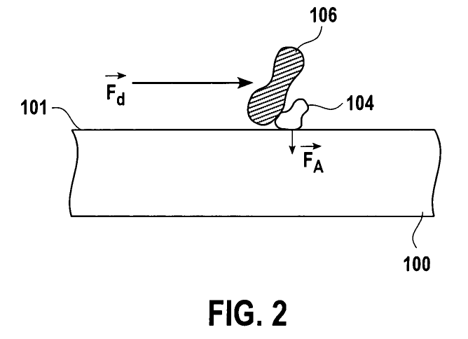

In FIG. 1, according to an embodiment of the present invention, is an illustration of the application of external energy 108 to bi-state body or tri-state body cleaning fluid 102 that results in interactions between particulate contaminants 104 adhered to a surface of the wafer and dispersed coupling elements 106 suspended within the cleaning fluid 102. Specifically, the application of external energy 108 to cleaning fluid 102 causes the creation of periodic shear stresses or pressure gradients 109 within cleaning fluid 102. As discussed below in more detail regarding FIG. 2, these periodic shear stresses or pressure gradients 109 impart momentum and/or drag forces on coupling elements 106 suspended within the cleaning fluid 102. These momentum and drag forces cause coupling elements 106 to interact with particulate contamination 104 adhered to wafer surface 101 in a manner that causes particulate contamination 104 to be lifted or moved away from or otherwise removed from wafer surface 101. As shown in FIG. 1 at 103, 105, 107, and discussed in further detail below regarding FIG. 2, the interaction between coupling elements 106 and contaminants 104 can be established through various mechanisms including, but not limited to, chemical or physical adhesion, collision (i.e., transfer of momentum or kinetic energy), repelling forces, attractive forces (e.g., steric forces, electrostatic forces, etc.), physical and chemical bonding (e.g., covalent or hydrogen bonding, etc.).

Unlike other wafer cleaning methods where momentum and drag forces are produced within multi-state body cleaning materials solely by acts such as: flowing cleaning media over wafer surfaces using jet assemblies or nozzles; dipping wafers into cleaning media, or mechanically agitating wafers or cleaning media by means such as shaking, stirring, or rotating and the like, momentum and drag forces are created according to embodiments of the present using the selectively controlled application of external energy 108 to cleaning fluid 102. According to embodiments of the present invention, the shear stresses or pressure gradients 109 created within the cleaning fluid 102 can be generated using various techniques including, but not limited to, megasonics, sonication, piezo electric or piezo acoustic actuation, cavitation, evaporation, or any combination thereof. In one embodiment of the present invention, energy 108 generated by such techniques can be applied to the wafer 100 which, in turn, transfers energy 108 to the cleaning fluid 102. In an alternative embodiment of the present invention, energy 108 can be applied directly to the cleaning fluid 102 from a confined source or to an entire system.

In FIG. 2, external energy 108 applied to cleaning fluid 102 to create periodic shear stresses \vec{τ} or pressure gradients within the cleaning fluid 102, according to embodiments of the present invention. Shear stress \vec{τ}, which is relevant to the motion of fluids in the vicinity of surfaces of a material, is a stress state where the stress is tangential to a surface of the material, as opposed to normal stress where the stress is normal to a surface of the material. The shear stress is periodic because the energy input is periodic. In one embodiment of the present invention, the periodic shear stress \vec{τ} created by the application of external energy 108 can impart a drag force F_{d} on coupling elements 106 within cleaning fluid 102 so that coupling elements 106 are brought within close proximity or contact with contaminants 104 adhered to wafer surface 101. Specifically, in one embodiment, external energy 108 is selectively applied to cleaning fluid 102 to allow the transfer of a shear force F_{d} of sufficient magnitude from coupling element 106 to contaminant 104 to overcome an adhesive force F_{A} between contaminant 104 and wafer surface 101, as well as any repulsive forces between coupling element 106 and contaminant 104. When coupling element 106 is moved within proximity to or contact with contaminant 104 to overcome the adhesive force F_{A}, interaction (or “coupling”) can occur between coupling element 106 and contaminant 104 through a variety of mechanisms.

One such coupling mechanism is mechanical coupling between coupling elements 106 and contaminants 104. For example, where coupling elements 106 are more malleable than contaminants 104, contaminant 104 can more easily adhere to coupling element 106. Here, upon coupling element 106 lifting away from wafer surface 101 as a result of the shear force F_{d}, contaminant 104 that is physically adhered with coupling element 106 is likewise lifted away from wafer surface 101. Additionally, where coupling elements 106 and contaminants 104 are less malleable and sufficiently rigid, the force of the coupling element 106 contacting contaminant 104 creates a substantially elastic collision causing contaminant 104 to lift away or dislodge from wafer surface 101. Here, the collision between coupling element 106 and contaminant 104 results in a significant transfer of energy (or momentum) from coupling element 106 to contaminant 104.

Another coupling mechanism is chemical coupling. In this case, where coupling elements 106 and contaminants 104 are chemically compatible, physical contact between coupling element 106 and contaminant 104 can cause chemical adhesion between coupling element 106 and contaminant 104.

In addition to the mechanical and chemical coupling mechanisms discussed above, electrostatic coupling can also occur. For example, where coupling elements 106 and contaminants 104 have opposite surface charges coupling elements 106 and contaminants 104 will be electrically attracted. Such electrical attraction can be of sufficient magnitude to overcome the adhesive force F_{A} attaching contaminant 104 to wafer surface 101. Alternatively, the electrostatic repulsive interaction between coupling elements 106 and contaminants 104 having substantially the same surface charges can be strong enough to dislodge contaminant 104 from wafer surface 101. It is important to note that one or more of the aforementioned coupling mechanisms including, but not limited to, mechanical, chemical, and electrostatic coupling, may be occurring at any given time regarding one or more contaminants 104 on the wafer surface 101.

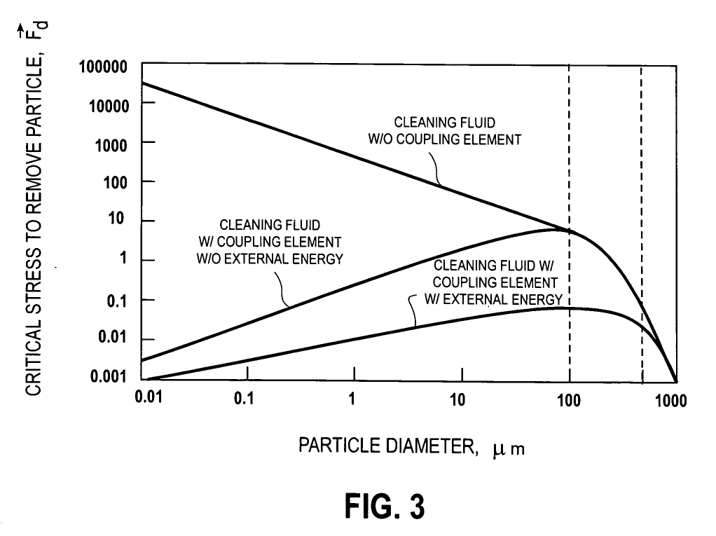

As illustrated in FIG. 3, it should be apparent that the application of external energy 108 which is transferred from cleaning fluid 102 to coupling elements 106 in the form of period shear stress (or pressure gradients) can increase wafer cleaning efficiencies. Specifically, as shown in FIG. 3, the amount of critical stress required to remove contaminants 104 having a particular size and dimension is significantly decreased when compared to other cleaning methods, according to embodiments of the present invention. For example, the amount of critical stress required to remove contaminant 104 having a diameter of approximately 0.1 μm employing the use of cleaning fluids that do not include coupling elements 106 is approximately 2000 Pa (stress applied in direction of adhesion). The amount of critical stress required to remove the same contaminant 104 utilizing cleaning fluids that include coupling elements 106 is approximately 0.3 Pa (shear stress acts on surface area of both coupling elements and particles (drag multiplier), whereas adhesion occurs only between the particle and surface, thus requiring significantly less shear for particle removal). According to embodiments of the present invention, the amount of critical stress required to remove the same contaminant 104 is respectively approximately 6000 times less than the amount of critical stress required for fluid-only approaches. Thus, the system can be operated at significantly lower power levels compared to fluid-only approaches eliminating damage to structures on the wafer

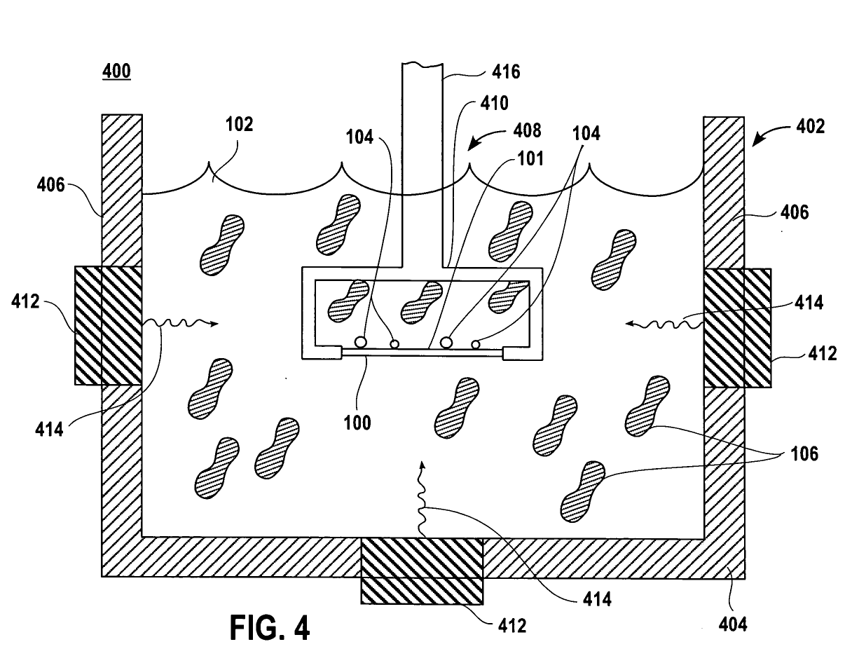

In FIG. 4, according to one embodiment of the present invention, is an illustration of a system 400 for removing contaminants 104 from surface 101 of wafer 100 by applying periodic stresses to cleaning fluid 102 including dispersed coupling elements 106. System 400 includes tank 402 having base 404, and sidewalls 406 that extend from base 404 to form cavity 408. The cavity 408 of tank 402 contains cleaning fluid 102. The wafer 100 is immersed in cleaning fluid 102 and supported by wafer carrier 410. However, any suitable means for immersing and supporting wafer 100 in cleaning fluid 102 can be used with embodiments of the present invention including, but not limited to, cassettes, grippers, holders, etc.

In one embodiment of the present invention, system 400 can include one or more megasonic transducers 412 coupled at base 404 and/or sidewalls 406 of tank 402. The megasonic transducers 412, in one embodiment of the present invention, are capable of applying high frequency megasonic acoustic energy 414 to the cleaning fluid 102. The frequency of the acoustic energy 414 applied to cleaning fluid 102 by megasonic transducers 412 can be selected from a range of approximately 600 MHz to approximately 3 MHz. For more information regarding megasonic transducers reference can be made to: U.S. Pat. No. 7,165,563, filed Dec. 19, 2002, entitled “Method and apparatus to decouple power and cavitation for megasonic cleaning”; U.S. Pat. No. 7,040,332, filed Feb. 28, 2003, entitled “Method and apparatus for megasonic cleaning with reflected acoustic waves”; and U.S. Pat. No. 7,040,330, filed Feb. 20, 2003, entitled “Method and apparatus for megasonic cleaning of patterned substrates.” Although a brief discussion of the components of bi-state and tri-state body cleaning technology is provided below, further explanation of the components and mechanisms of tri-state body cleaning technology can be found by reference to: U.S. patent application Ser. No. (11/346,894) (Atty. Docket No. LAM2P546), filed Feb. 3, 2006, entitled “Method for removing contamination from a substrate and for making a cleaning solution”; U.S. patent application Ser. No. 11/347,154 (Atty. Docket No. LAM2P547), filed Feb. 3, 2006, entitled “Cleaning compound and method and system for using the cleaning compound”; and U.S. patent application Ser. No. (11/336,215) (Atty. Docket No. LAM2P545), filed Jan. 20, 2006, entitled “Method and Apparatus for removing contamination from a substrate.” The aforementioned patents and patent applications are hereby incorporated by reference in their entirety. By applying megasonic energy 414 to cleaning fluid 102, periodic shear stresses are generated that impart drag forces F_{d} on coupling elements 106 causing coupling elements 106 to interact with contaminants 104 adhered to wafer surface 101 thereby removing contaminants 104 from wafer surface 101. Moreover, by applying megasonic energy 414 to cleaning fluid 102, the magnitude of drag forces F_{d} on coupling elements 106 is increased due to energy contributions from cavitation. Cavitation is the rapid forming and collapsing of microscopic bubbles generated from dissolved gas when sonic energy (e.g. megasonic or ultrasonic etc.) is applied to a liquid medium. Here, upon collapse, the bubbles release energy that combines with energy 414 applied by megasonic transducers 412 to produce greater drag forces F_{d}.

In an alternate embodiment of the system 400, sonication can be utilized to apply energy 414 to cleaning fluid 102. Specifically, megasonic transducers of system 400 can be substituted with transducers that apply ultrasonic energy or any other acoustic energy to cleaning fluid 102. As recognized by those of ordinary skill, sonication usually involves the application of ultrasonic energy to a medium to agitate particles contained within the medium. In one embodiment of the present invention, by applying ultrasonic energy to cleaning fluid 102, periodic shear stresses can also be generated that impart drag forces F_{d} on coupling elements 106 causing coupling elements 106 to interact with contaminants 104 to remove contaminants 104 from wafer surface 101. In one embodiment of the present invention, frequency of the ultrasonic energy can be selected from a range of approximately 50 Hz to approximately 100 KHz.

In a further alternate embodiment, the megasonic transducers 412 or any other transducer of the system 400 can be removed and low frequency acoustic energy can be applied to the cleaning fluid 102 through the carrier 410. Specifically, in one embodiment, low frequency acoustic energy (e.g. ultrasonic energy) can travel through a holder 416 of carrier 410 to carrier 410 where the low frequency acoustic energy is then transferred from carrier 410 into cleaning fluid 102. In one embodiment, the low frequency acoustic energy can have a frequency of approximately 50 Hz to approximately 100 KHz. As discussed above, the application of energy 414 to cleaning fluid 102 generates motion in cleaning fluid 102 that impart drag and/or momentum forces on coupling elements 106 suspended in cleaning fluid 102. These forces cause interactions between coupling elements 106 and contaminants 104 on wafer surface 101 causing the removal of contaminants 104 from wafer surface 101.

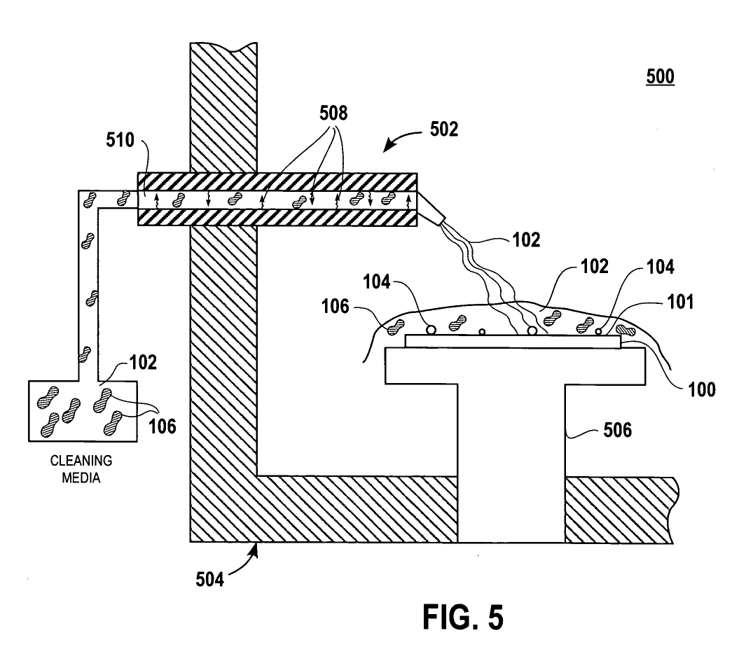

In FIG. 5, according to one embodiment of the present invention, is an illustration of a system 500 including jet assembly 502 for removing particulate contamination 104 from surface 101 of wafer 100. System 500 includes processing chamber 504 that in turn includes carrier 506, or any other suitable means for supporting wafer 100. In one embodiment of the present invention, jet assembly 502 is capable of generating acoustic energy 508 (e.g. megasonic, ultrasonic, etc.) so that as cleaning fluid 102 including coupling elements 106 passes along throughway 510 of jet assembly 502, acoustic energy 508 is applied to cleaning fluid 102 altering the characteristics of the cleaning fluid 102 before cleaning fluid 102 is sprayed onto exposed surface 101 of wafer 100. In particular, according to one embodiment, by applying acoustic energy 508 to cleaning fluid 102, each of coupling elements 106 can become physically altered (e.g., size, shape, etc.). For example, according to one embodiment of the present invention, a size distribution of an altered coupling element 106 can broaden, narrow, or shift to a smaller mean size. As a result, altered coupling elements 106 have an improved interaction with contaminants 104 on wafer surface 100 which, in turn, provides a corresponding enhancement in each of the altered coupling element's 106 ability to remove contaminants 104. Additionally, the fluid motion from a jet of the jet assembly 502 can imparts a force on altered coupling elements 106 causing one or more altered coupling elements 106 to interact with particulate contaminants 104 to remove contaminants 104 from wafer surface 100.

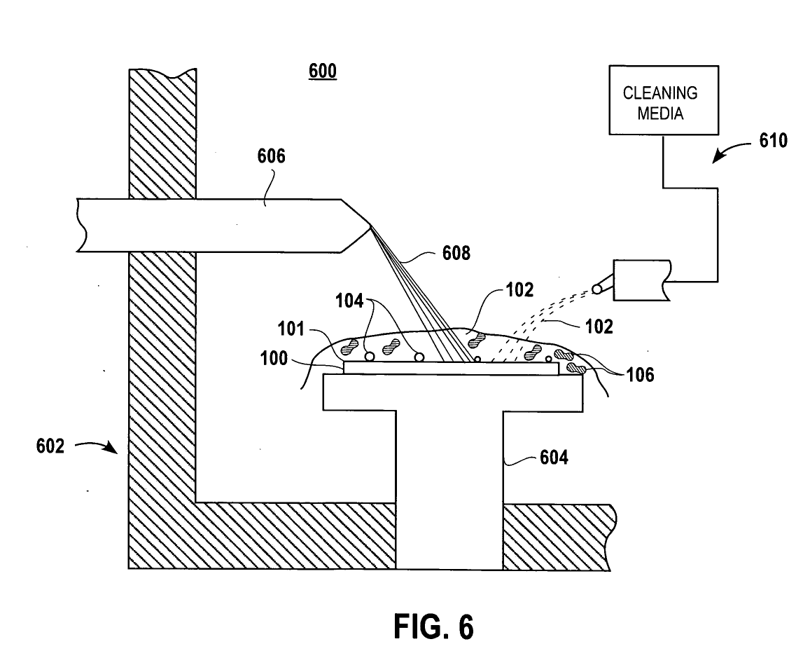

In FIG. 6, according to one embodiment of the present invention, is an illustration of a system 600 for removing contaminants 104 from exposed surface 101 of wafer 100. The system 600 includes a processing chamber 602 that includes a carrier 604 or any other suitable means for supporting wafer 100. The system 600 further includes an energy source 606 capable of radiating acoustic energy 608 into cleaning fluid 102 including dispersed coupling elements 106 while, at the same time, cleaning fluid 102 is sprayed onto exposed wafer surface 101 utilizing a fluid supply assembly 610. In one embodiment of the present invention, the energy source 606 can include a transducer element (e.g. megasonic, ultrasonic, etc.) or any other element capable of generating and applying acoustic energy 608 to cleaning fluid 102. Here again, in one embodiment of the present invention, coupling elements 106 suspended within cleaning fluid 102 contact exposed wafer surface 101 through acoustically generated convection thereby interacting with and removing contaminants 104 from exposed wafer surface 101.

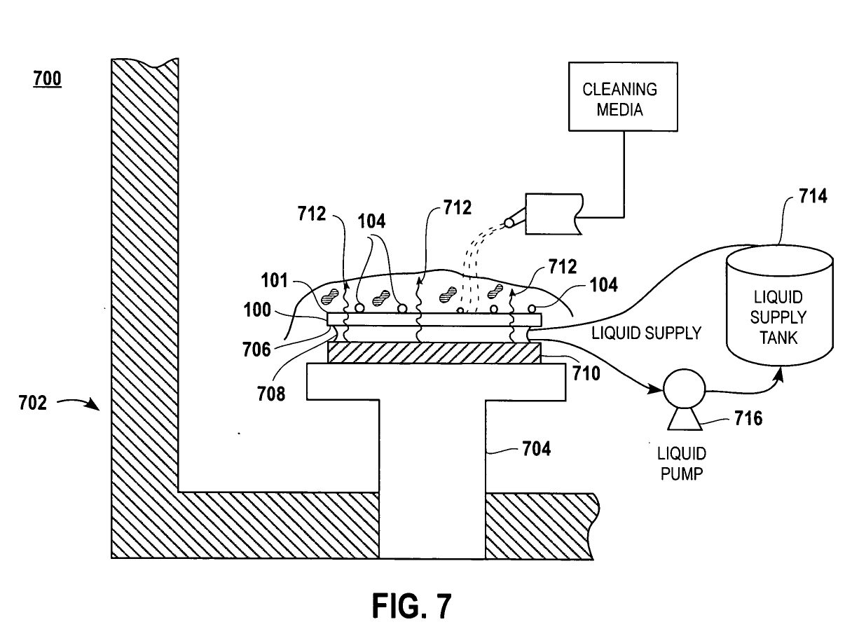

In FIG. 7, according to one embodiment of the present invention, is an illustration of a system 700 for removing contaminants 104 from exposed front surface 101 of wafer 100. The system 700 includes processing chamber 702 that includes carrier 704 or any other suitable means for supporting wafer 100. At back surface 706 of wafer 100 opposite exposed front wafer surface 101, the system 700 further includes liquid layer 708 proximally located to back surface 706 and between back wafer surface 706 and transducer 710. In one embodiment of the present invention, transducer 710 can be any transducer capable of generating acoustic energy 712 including, but not limited to, megasonic energy, ultrasonic energy, etc. In one embodiment of the present invention, liquid layer 708 is provided as a medium for transferring acoustic energy 712 generated from transducer 710 to wafer 100. In one embodiment of the present invention, the liquid forming liquid layer 708 can be deionized water, an ammonia hydrogen peroxide mixture (APM), a surfactant solution, or a non-aqueous liquid. The supply and reclaim of the liquid which forms liquid layer 708 can achieved by the circulation of the liquid from supply tank 714 to liquid layer 708 and back to supply tank 714 via liquid pump 716, according to one embodiment of the present invention. Additionally, liquid layer 708 can be formed between back surface 706 and transducer 710 in any manner recognized by those of ordinary skill.

Referring still to FIG. 7, according to one embodiment of the present invention, acoustic energy 712 from transducer 710 is transferred through the liquid layer 708 to wafer 100, through wafer 100 into cleaning fluid 102 at exposed wafer surface 101 on front side of wafer 100. In this case, acoustic energy 712 is applied to wafer 100 and wafer 100 transfers energy 712 to cleaning fluid 102. An advantage of applying energy 712 to wafer 100 rather than directly into cleaning fluid 102 is that less energy is dissipated.

As mentioned above, various techniques for applying external energy to cleaning fluids 102 to remove contaminants 104 from wafer surfaces 101 can be provided according to alternate embodiments of the present invention. For example, in one embodiment of the present invention, piezoelectric or piezo acoustic actuation can be used. For piezoelectric actuation, the walls or specific areas of a containment vessel can be periodically perturbed (via piezoelectric materials) resulting in volume changes and fluid motion within the containment vessel. The fluid motion enhances drag over the wafer surface and contamination removal. In another example, according to one embodiment of the present invention, evaporation can be used. Here, evaporation induces bulk motion of the fluid and enhances drag on the wafer surface facilitating contamination removal.

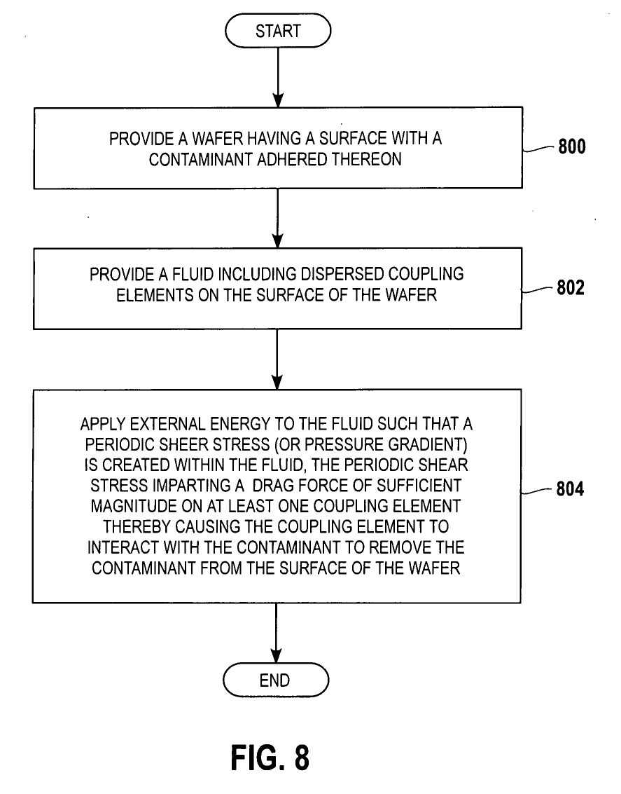

In FIG. 8, according to one embodiment of the present invention, is a method for removing contaminants 104 from a surface 101 of a wafer 100. At step 800, a wafer 100 having particulate contaminants 104 adhered to the surface 101 is provided. At step 802, a cleaning fluid 102 including dispersed coupling elements 106 suspended within the cleaning fluid 102 is applied to the wafer surface 101. As discussed above, the cleaning fluid 102 can be a bi-state body or tri-state body fluid, or any other cleaning fluid, solution or material that is engineered to include dispersed suspended solid phase components (coupling elements) 106. In one embodiment of the present invention, the cleaning fluid 102 can be applied to the wafer surface 101 by immersing the entire wafer 100 in the cleaning fluid 102. For example, as shown in FIG. 4, a tank system 400 can be used to immerse the wafer 100 in the cleaning fluid 102. However, embodiments of the present invention are not limited to the particular system for immersing the wafer 100 in the cleaning fluid 102. In an alternate embodiment of the present invention, the cleaning fluid 102 can be spread over one or more exposed surfaces 101 of the wafer 100 using jet assemblies, spray nozzles, etc. For example, as illustrated in FIGS. 5-7.

At step 804, external energy is applied to the cleaning fluid 102 to create periodic shear stresses (or pressure gradients) within the cleaning fluid 102. As previously discussed, periodic shear stresses impart drag and/or momentum on the coupling elements 106 suspended within the cleaning fluid 102. As a result, the coupling elements 106 collide with the wafer surface 101 causing interactions between the coupling elements 106 and the contaminants 104 that facilitate the removal of contaminants 104 adhered to the wafer surface 101. In other words, the coupling elements 106 suspended within the cleaning fluid 102 contact the wafer surface 101 through acoustically, mechanically, etc. generated convection thereby interacting with and removing contamination 104 from the wafer surface 101. According to embodiments of the present invention, the shear stresses or pressure gradients can be generated using various techniques including, but not limited to, megasonics, sonication, piezo electric or piezo acoustic actuation, cavitation, evaporation, etc. For example, FIGS. 4-7 provide examples of the application of external energy to the cleaning fluid using one or a combination of megasonics, sonication, and cavitation techniques. In one embodiment of the present invention, the energy can be applied to the cleaning fluid 102 directly at a confined source or to an entire system, for example as illustrated in FIGS. 4-6. In alternate embodiment of the present invention, the energy can be applied to the wafer 100 where the wafer 100 transfers the energy to the fluid 102, for example as illustrated in FIG. 7.

In view of the discussion above, it should be apparent that embodiments of the present invention provide an efficient approach to cleaning techniques for integrated post-etch cleaning, stand-alone wafer cleaning applications, or any other wafer cleaning techniques or applications that require the removal of contamination from wafer surfaces. According to embodiments of the present invention, through the application of external energy to cleaning fluids with solid phase coupling elements, contaminant removal efficiency is enhanced by providing additional agitation and/or motion control to the coupling elements suspended within the cleaning fluids. Moreover, by controlling how and with what magnitude the external energy is applied to cleaning fluids, the shear stress forces generated by such application of energy can be more closely controlled which in turn eliminates undesired device damage. Additionally, since the mechanism of removal is a controlled momentum transfer, it possible that cleaning solutions or fluids with lower concentrations of coupling elements can be used.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for cleaning, comprising:
providing a wafer having a surface, the surface having a particle thereon;
providing a cleaning media on the surface, the cleaning media including one or more dispersed coupling elements suspended therein; and
applying external energy to the cleaning media, the application of the external energy to the cleaning media generating a periodic shear stress within the cleaning media,
wherein the periodic shear stress imparts a force on at least one of the one or more of the coupling elements, the force causing an interaction between the at least one of the one or more coupling elements and the particle to remove the particle from the surface.

2. The cleaning method as recited in claim 1, wherein applying the external energy to the cleaning media includes applying the external energy using one or more of megasonics, sonication, piezo electric actuation, piezo acoustic actuation, cavitation, and evaporation.

3. The cleaning method as recited in claim 2, wherein the external energy is applied to the cleaning media via the wafer, wherein the wafer transfers the external energy to the cleaning media.

4. The cleaning method as recited in claim 2, wherein the external energy is applied directly to the cleaning media from a confined source.

5. The cleaning method as recited in claim 1, wherein the external energy is high frequency megasonic acoustic energy having a frequency of approximately 600 KHz to approximately 3 MHz.

6. The cleaning method as recited in claim 1, wherein the external energy is ultrasonic energy having a frequency of approximately 50 Hz to approximately 100 KHz.

7. The cleaning method as recited in claim 1, wherein the interaction is defined by one or more of mechanical coupling, chemical coupling, or electrostatic coupling between the at least one of the one or more coupling elements and the particle.

8. The cleaning method as recited in claim 7, wherein the mechanical coupling is defined by adhesion between the at least one of the one or more coupling elements and the particle, such that the particle is lifted away from the surface along with the at least one of the one or more coupling elements.

9. The cleaning method as recited in claim 7, wherein the mechanical coupling is defined by a physical collision between the at least one of the one or more coupling elements and the particle, such that a transfer of energy from the at least one of the one or more coupling elements to the particle causes the particle to lift away from the surface.

10. The cleaning method as recited in claim 7, wherein the chemical coupling is defined by physical contact and chemical compatibility between the at least one of the one or more coupling elements and the particle, the physical contact facilitating chemical adhesion between the at least one of the one or more coupling elements and the particle.

11. The cleaning method as recited in claim 7, wherein the electrostatic coupling is defined by an attractive or repulsive interaction between the at least one of the one or more coupling elements and the particle.

12. The cleaning method as recited in claim 1, wherein the force is defined by drag or momentum or a combination thereof.

13. The cleaning method as recited in claim 1, wherein the cleaning media includes one of:
a liquid component, a gas component, and a solid component; or
a liquid component and a solid component.

14. The cleaning method as recited in claim 13, wherein the solid component corresponds to the one or more dispersed coupling elements.

15. The cleaning method as recited in claim 14, wherein the solid component is one of a material of aliphatic acids, carboxylic acids, paraffin, wax, polymers, polystyrene, polypeptides, fatty acids, and visco-elastics.

16. The cleaning method as recited in claim 13, wherein the gas component is one of a gas mixture of:
ozone (O₃), oxygen (O₂), hydrochloric acid (HCl), hydrofluoric acid (HF), nitrogen (N₂), and argon (Ar);
ozone (O₃) and nitrogen (N₂);
ozone (O₃) and argon (Ar);
ozone (O₃), oxygen (O₂) and nitrogen (N₂);
ozone (O₃), oxygen (O₂) and argon (Ar);
ozone (O₃), oxygen (O₂), nitrogen (N₂), and argon (Ar); and
oxygen (O₂), argon (Ar) and nitrogen (N₂).

17. The cleaning method as recited in claim 13, wherein the liquid component is aqueous or non-aqueous.

18. A system for cleaning, comprising:
a carrier for supporting a wafer having a surface, the surface having a particle thereon;
a tank having a cavity defined by a base and one or more sidewalls extending therefrom, the tank being configured to hold a volume of a cleaning media within the cavity to immerse the wafer, wherein the cleaning media includes one or more dispersed coupling elements suspended therein; and
one or more transducers coupled to at least one of the one or more sidewalls or the base, the one or more transducers applying acoustic energy to the cleaning media,
wherein the acoustic energy generates a periodic shear stress within the cleaning media, and
wherein the periodic shear stress imparts a force on at least one of the one or more dispersed coupling elements causing the at least one of the one or more dispersed coupling element to interact with the particle to facilitate the removal of the particle from the surface.

19. The system as recited in claim 18, wherein the transducer is a megasonic transducer or an ultrasonic transducer.

20. The system as recited in claim 19, wherein the transducer is the megasonic transducer, and wherein a frequency of the acoustic energy is from approximately 600 KHz to approximately 3 MHz.

21. The system as recited in claim 19, wherein the transducer is the ultrasonic transducer, and wherein a frequency of the acoustic energy is from approximately 50 Hz to approximately 100 KHz.

22. A system for cleaning, comprising:
a processing chamber having a carrier element, the carrier element being capable of supporting a wafer within the processing chamber such that a surface of the wafer is exposed, the exposed wafer surface having a particle thereon; and
a jet assembly, wherein the jet assembly is configured to generate acoustic energy, apply the acoustic energy to a cleaning media as the cleaning media travels along a throughway of the jet assembly, wherein the cleaning media includes one or more dispersed coupling elements suspended therein and the acoustic energy alters a physical characteristic of each of the dispersed coupling elements before application of the cleaning media to the exposed wafer surface, and wherein fluid motion from a jet of the jet assembly imparts a force on at least one of the altered one or more dispersed coupling elements causing the at least one of the altered one or more dispersed coupling element to interact with the particle to remove the particle from the exposed wafer surface.

23. The system as recited in claim 22, wherein each of the altered coupling elements enhance removal of the particle from the exposed wafers surface.

24. The system as recited in claim 22, wherein a size distribution of each of the altered coupling elements broadens, narrows, or shifts to a smaller mean size.

25. The system as recited in claim 22, wherein the physical characteristic of each of the coupling elements is one or more of size and shape.

26. A system for cleaning, comprising:
a processing chamber having a carrier element, the carrier element being capable of supporting a wafer within the processing chamber such that a surface of the wafer having a particle disposed thereon is exposed;
a fluid supply assembly, the fluid supply assembly being configured to supply a cleaning media to the surface, the cleaning media including one or more dispersed coupling elements suspended therein; and
a energy source capable of generating acoustic energy, wherein the acoustic energy is applied to cleaning media at surface, thereby generating a periodic shear stress within the cleaning media, the periodic shear stress imparting a force on at least one of the one or more dispersed coupling elements causing the at least one of the one or more dispersed coupling element to interact with the particle to remove the particle from the surface.

27. A system for cleaning, comprising:
a transducer capable of generating acoustic energy disposed proximal to a back surface of a wafer, the wafer including a front surface opposite the back surface, the front surface having a particle thereon;
a first fluid supply assembly, the first fluid supply assembly being capable of supplying a liquid layer between the back surface of the wafer and the transducer;
a second fluid supply assembly, the second fluid supply assembly being capable of supplying a cleaning media including one or more dispersed coupling elements suspended therein on the front surface of the wafer,
wherein the acoustic energy is transferred from the transducer through the liquid layer and the wafer into the cleaning media at the front surface of the wafer, thereby generating a periodic shear stress within the cleaning media, the periodic shear stress imparting a force on at least one of the one or more dispersed coupling elements causing the at least one of the one or more dispersed coupling element to interact with the particle to remove the particle from the front surface.

28. The system as recited in claim 27, wherein the transducer is a megasonic transducer or an ultrasonic transducer.

29. The system as recited in claim 28, wherein the transducer is the megasonic transducer, and wherein a frequency of the acoustic energy is from approximately 600 KHz to approximately 3 MHz.

30. The system as recited in claim 28, wherein the transducer is the ultrasonic transducer, and wherein a frequency of the acoustic energy is from approximately 50 Hz to approximately 100 KHz.

31. The system as recited in claim in claim 27, wherein the liquid layer is one of deionized wafer, ammonia hydrogen peroxide mixture (APM), surfactant solution, or non-aqueous liquid.
